(19) United States
(12) Patent Application Publication
(10) Pub. No.: US 2025/0037222 A1
(43) Pub. Date: Jan. 30, 2025

(54) METHOD OF CONDUCTING LEGAL RESEARCH AND CREATING LEGAL WORK PRODUCT

(71) Applicant: Ayomide Oluleye, RESTON, VA (US)

(72) Inventor: Ayomide Oluleye, RESTON, VA (US)

(21) Appl. No.: 18/784,791

(22) Filed: Jul. 25, 2024

Related U.S. Application Data
(60) Provisional application No. 63/529,680, filed on Jul. 29, 2023.

(51) Int. Cl. G06Q 50/18; G06F 3/0486; G06F 16/33; G06F 40/134

(52) U.S. Cl. CPC G06Q 50/18; G06F 3/0486; G06F 16/3344; G06F 40/134

(57) ABSTRACT

This system provides improved methods for processes like legal research and legal work product generation that combine the advantages of AIs ability to sift vast amounts of data for particular sought-after results, with the ability to apply judgment or “common sense” of a user. The system provides the initial benefits of AI and machine learning, that provides templates, information, guidance and suggestions, and is constantly improved; but that provides user oversight. The system can provide “puzzle pieces” as suggestions for specific points of most needed oversight. This provides a “gamification” aspect as the user seeks to improve results, as in a game.

### CROSS REFERENCE TO RELATED APPLICATION(S)

This application claims the benefit of, U.S. Provisional Application No. 63/529,680 entitled “IMPROVED METHOD OF CREATING IMPROVED LEGAL RESEARCH AND LEGAL WORK PRODUCT,” filed on Jul. 29, 2023.

The subject matter of this application is hereby incorporated by reference in its entirety.

### TECHNICAL FIELD OF THE INVENTION

The present invention relates to the general field of information technology and software. Specifically, the invention improves the method and quality of legal research and legal drafting through a machine learning and artificial intelligence-enabled approach with gamified aspects.

### BACKGROUND

To advise and represent clients to the best of their abilities, attorneys often have to perform legal research and draft bespoke legal documents which requires substantive time commitments and research expertise. However, most attorneys are short on time and spend too much of their limited time on inefficient legal research and drafting methods. What attorneys need, and what this invention provides, is an improved way to conduct research that eliminates the need to constantly revise search queries combined with explainable and intuitive artificial intelligence (AI) for drafting work product.

The current options available to attorneys fall into three categories: (1) consumer search engines, (2) traditional legal research platforms, and (3) AI chatbots-provided by new market entrants or traditional legal research platforms. However, due to inherent limitations, none of the current options fully and independently satisfy the needs of attorneys.

Semantic search functionality available on consumer search engines allows attorneys to intuitively use natural language queries to access websites offering no cost legal commentary and primary sources to the public. Some consumer search engines provide automated concise excerpts above the search results when the algorithms find appropriate matches, allowing attorneys to quickly direct their attention to a search result that may contain information directly on point as opposed to scrolling through many results. Consumer search engines crawl and index websites and use ranking algorithms to recommend relevant web pages based on the semantic meaning of users' queries. Many attorneys initiate legal research on consumer search engines, rather than the traditional legal research platforms they subscribe to, due to the ease of use consumer search engines provide. However, such services are not designed for legal research and, as such, are not able to address complex legal issues. The currency and quality of the publicly available information consumer search engines index can vary significantly across jurisdictions and practice areas. Not only do these consumer options lack specific legal content attorneys need, but attorneys are unable to complete the legal drafting process within the search engines, which is a vital component of attorneys' workflow and inextricably linked with the research process.

Next, there are traditional legal research platforms that carry many of the legal sources attorneys need that are not available on consumer search engines. However, while these platforms have the resources attorneys need to complete their research, inherent limitations severely constrain the ability of attorneys to access relevant resources in a timely manner. Traditional legal research platforms rely on keyword matching or Boolean terms and connectors rather than semantic search to retrieve results. They also provide legal citators and digests to show, respectively, whether a resource is still good law according to a human analyst or where it falls in a hierarchy of topics organized by human editors. The subjective, rigid, and generic qualities of legal citators and digests cause attorneys to miss out on relevant information either through incorrect or inadequate citation treatment categories or unintuitive classification and display of topics. In short, while the platforms offer more legal content than consumer search engines, their complex user requirements are a barrier for attorneys to complete robust research. While these platforms often house relevant information and offer limited legal drafting tools, their reliance on keyword and Boolean approaches require attorneys to constantly revise queries to get relevant results. Moreover, legal citators and digests can frustrate attorneys with mislabeled or misclassified content.

Lastly, AI chatbots generate fully textual responses to user prompts that are semantically relevant and often well-formatted. The fully textual responses AI chatbots generate are seemingly lawyerly, in some cases. AI chatbots work by leveraging large language models (LLMs) trained on vast data sets of human-written text, combined with advanced natural language processing (NLP) algorithms and sophisticated machine learning (ML) techniques. An AI chatbot sequentially predicts tokens (re: words) based on embeddings of the user's prompt and the tokens previously generated by the chatbot in response to the user's prompt. This architecture positions AI chatbots to address legal research and drafting use cases, either in the form of short Q&A-style responses or long form text that resembles formal legal documents. Generative AI responses that, in some cases, include footnotes to specific legal authorities, are supposed to save attorneys time, particularly on drafting tasks. However, approaches that rely mostly on textual responses can both blossom with impressive syntax and wither with misleading information. Limitations in training data sets cause AI chatbots to misunderstand language, misinterpret context, and make factual errors. Under current approaches, chatbots convey these falsehoods in the same winsome, articulate manner as facts since they do not have a method for unilaterally disclosing the errors they generate. This puts pressure on attorneys to recognize errors made by AI chatbots, typically black box systems, without an integrated and comprehensive approach to finding helpful answers, that exists outside of unremittingly adding prompts for the AI chatbot to revise its response to align with an attorney's intent more closely.

The invention, outlined below, is poised to remedy these challenges.

### SUMMARY

The following presents a simplified summary of the disclosure to provide a basic understanding of the invention. This summary is not, nor is it meant to be, an all-encompassing overview of the disclosure and may not identify some elements of the invention or define its complete scope. Its purpose is to present at least some disclosed concepts in a simplified form as a precursor to the more detailed description that is later presented.

The system provides improved methods for conducting legal research and drafting legal documents by integrating semantic search functionality, automated relevance showcasing of each search result, and intuitive and explainable generative AI. For legal research, the system eliminates the need to constantly revise keywords or scroll incessantly through search results by offering relevant search results through semantic search and employing algorithms to display for each result the issues and facts relevant to the user's query along with related issues and analogous facts. For legal drafting, the system provides AI-generated provisional responses modulated by hyperlinked “missing puzzle pieces” integrated with the system's legal research embodiments. When clicked, each puzzle piece displays automated search results relevant to the particular section of the provisional response and the user's original prompt. Attorneys are able to create a draft from the provisional response by copying relevant selections from the search results back into the provisional response via drag and drop functionality. In some embodiments, the system uses algorithms to rate the “fit” of the user's selection according to a green-yellow-red color scheme. The system described herein is applicable, but not limited to the legal domain.

### BRIEF DESCRIPTION OF THE DRAWINGS

FIG. 1 is a schematic diagram of the steps of embodiments of the invention pertaining to the research module.

FIG. 1A is a schematic diagram of an alternative embodiment of a portion of the invention concerning computerization.

FIG. 1B is a schematic diagram of another alternative embodiment of a portion of the invention concerning computerization.

FIG. 2 illustrates a research module system overview method, performed in accordance with one or more embodiments.

FIG. 3 is a schematic diagram of the steps of other embodiments of the invention pertaining to the drafting module.

FIG. 4 illustrates a drafting module system overview method, performed in accordance with one or more embodiments.

FIG. 5 is a schematic visual representation of another portion of the embodiments of FIG. 3.

FIG. 6 is a schematic visual representation of another portion of the embodiments of FIG. 3.

FIG. 7 is a schematic visual representation of another portion of the embodiments of FIG. 3.

FIG. 8 is a schematic visual representation of another portion of the embodiments of FIG. 3.

FIG. 9 is a schematic visual representation of another portion of the embodiments of FIG. 3.

FIG. 10 is a schematic visual representation of another portion of the embodiments of FIG. 3.

FIG. 11 is a schematic visual representation of another portion of the embodiment of FIG. 3.

FIG. 12 is a schematic visual representation of another portion of the embodiment of FIG. 3.

### DETAILED DESCRIPTION OF PREFERRED EMBODIMENTS

Shown and described herein is a system 2, featuring a number of embodiment methods for completing legal research and/or drafting tasks that leverages components such as semantic search, machine learning, generative AI, color-coded ratings, and elements of puzzle making gamification.

The system 2 herein allows for legal research with the advantages of natural language queries, transparent quantitative and qualitative ranking factors, and automatic retrieval of relevant legal issues and facts. Further, the system provides for legal drafting with the advantages of generated provisional responses integrated with legal research workflow, allowing for human oversight and game-like aspects to increase motivation and interest. This invention improves the functionality and accuracy of legal research and drafting, increases efficiency, and improves confidence in the resultant work products.

This reliable, time-saving system 2 has various use cases. It can be used by any person in a position to be drafting legal or other formal documents, such as legal professionals. It is to be understood that the term “attorney” or “legal professional” means any such person in a position to be researching or drafting legal or other similarly formal documents, which includes, but is not limited to, attorneys, paralegals, legal secretaries, law school students, and law school professors.

According to an embodiment, techniques and mechanisms described herein may be used for semantic search to allow users to search in legal domain specific natural language that yields results reflecting the intent behind their queries. Semantic search is the foundational touchpoint for the system's users because it is how users initiate the system's 2 method of efficient, time-saving legal research. Semantic search is to the system like a steering wheel is to a vehicle or a mouse is to a personal computer. All are underpinned by engineering that allows users to reliably reach their intended destinations. Subsequent techniques and mechanisms may be used to ensure that search results are relevant and navigation is seamless.

According to an embodiment, techniques and mechanisms described herein may be used to save attorneys' time by providing them with an improved method for determining whether a search result is still good law for their specific research objectives. The system shows users both quantitative and qualitative ranking factors based on semantic understanding of their queries.

According to an embodiment, techniques and mechanisms described herein may be used to display relevant legal issues and facts on the search results page and the reference page that are specific to the semantic meaning of the user's query. This provides attorneys with a more reliable and robust way of forming initial assessments of a reference's relevance, overcoming limitations found in extracts and legal taxonomies under current approaches.

According to an embodiment, techniques and mechanisms described herein may be used to streamline the way attorneys find related legal issues and analogous facts. The system 2 surmounts limitations found in legal taxonomies and keyword search engines that cause attorneys to waste time on unintuitive, manual, and repetitive approaches. Instead, the system 2 saves attorneys time by anticipating future directions of research and allowing attorneys to access these additional references without the need to constantly revise keywords.

According to an embodiment, techniques and mechanisms described herein may be used to mitigate inherent risks of AI chatbots evident under current approaches in a manner that promotes trust and adoption in legal AI. By taking a modular approach that involves producing hyperlinked puzzle pieces in place of pivotal text, the system 2 eschews follow up prompts and fully textual responses in favor of provisional responses.

According to an embodiment, techniques and mechanisms described herein may be used to integrate a display containing a provisional response with an adjacent display with automated search results. In doing so, the system 2 goes beyond conversation-based applications of generative AI that necessitate incessant follow up prompts from users. Attorneys are experienced in reviewing legal documents and keying in on particular language for further investigation so a provisional response, modulated by hyperlinked puzzle pieces, aligns well with how attorneys form legal questions and pursue answers.

According to an embodiment, techniques and mechanisms described herein may be used to uphold transparency and save time by emphasizing human oversight of the system's 2 generative AI application while enhancing attorneys' legal research with machine learning capabilities that anticipates future directions of research. By integrating provisional responses to prompts with streamlined legal research functionality, the system 2 does not rely on its models to generate fully textual responses nor does it use its search features to single out references for AI-summarization or citation. Instead, the system 2 generates a provisional response modulated by clickable puzzle pieces that point users to automated search results outfitted with research capabilities of various embodiments such that users do not need to engage in incessant prompts or constantly revise search queries.

According to an embodiment, techniques and mechanisms described herein may be used to effectively eliminate the false choice between efficiency and quality that attorneys face under current approaches. By incorporating puzzle solving functionality into its provisional responses, the system, instead of forcing attorneys to sacrifice one for the other, allows them to achieve both efficiency and quality seamlessly. In doing so, the system empowers attorneys to consistently deliver exceptional value to their clients.

According to an embodiment, techniques and mechanisms described herein may be used to cohere puzzle insertions in a provisional response into a completed draft. By making explicit the need for human oversight of generative AI and providing streamlined and engaging functionality for an efficient interactive experience, the system takes the best that AI has to offer along with the expertise attorneys possess to deliver a user experience that enhances the performance of both. The system's 2 coherence techniques are consistent with an overall method of eliminating the need for attorneys to constantly revise queries, prompts, and in this embodiment, drafts.

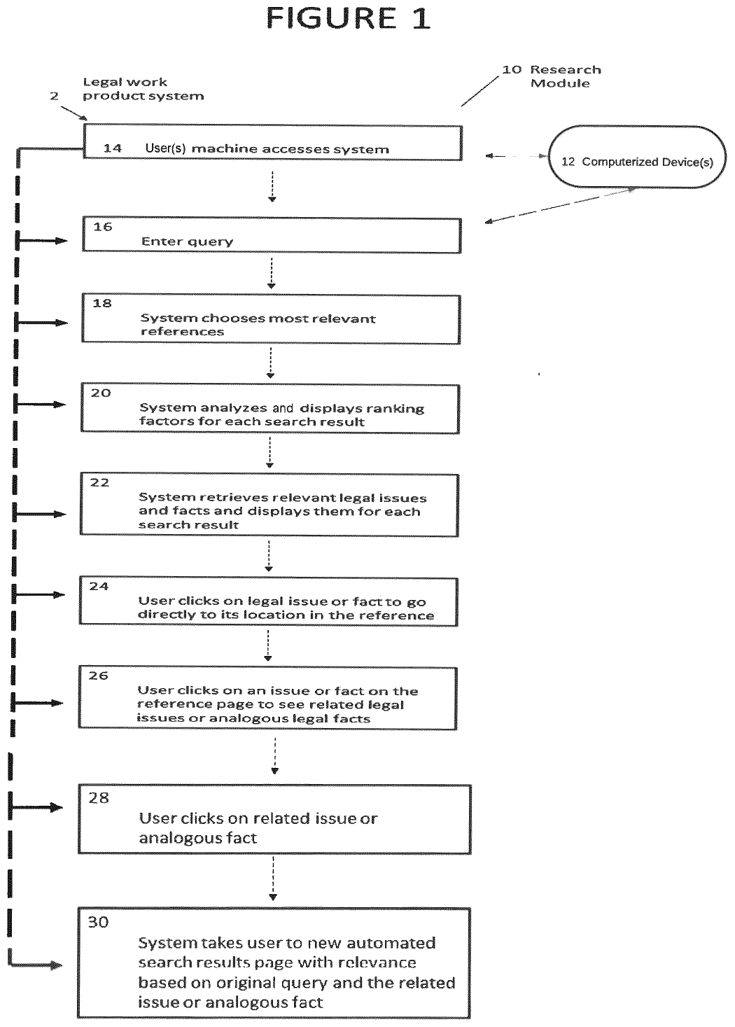

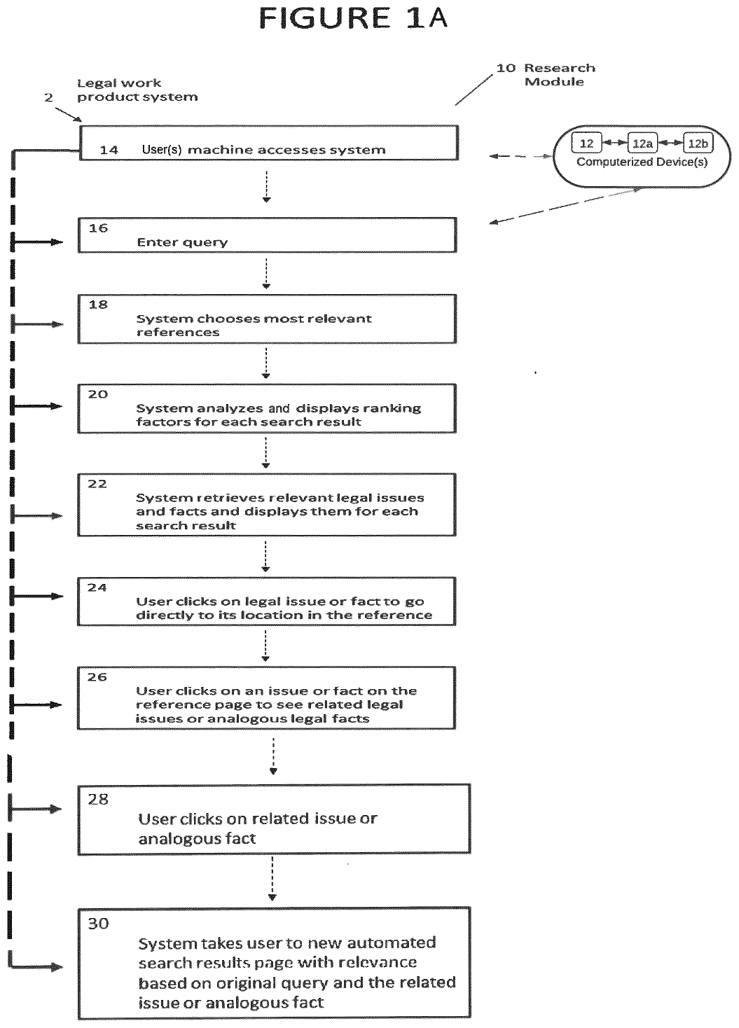

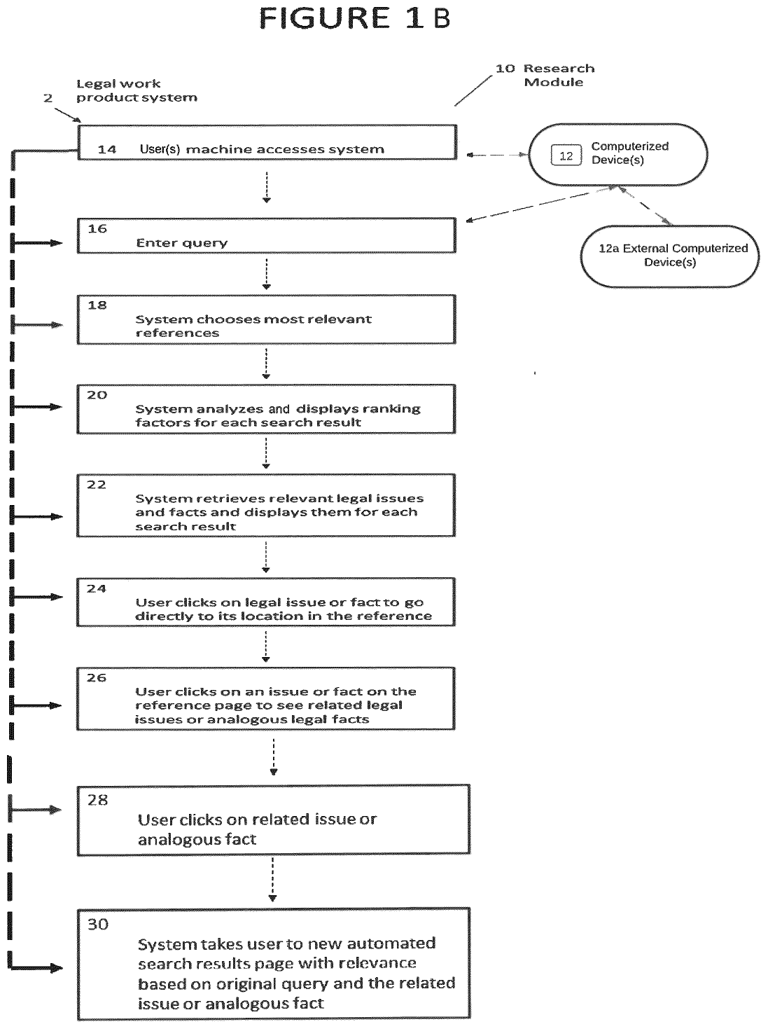

Turning to FIG. 1, an overview of the research module 10 is shown. The relevant software of the system 2 is preprogrammed and added to at least one computerized device 12. At least one user interacts with the at least one computerized device 12, running the software to implement various modules to accomplish set tasks with the system 2.

Turning briefly to FIGS. 1-1B, the at least one computerized device 12 can be comprised of at least one of any suitable computerized devices known in the art, which can include, e.g., a server, personal computer, laptop, smartphone, or tablet. Further, the at least one computerized device 12 can be comprised of, in a number of embodiments, varying numbers, forms, and structures.

A few representative configurations of the at least one computerized device 12, 12a, 12b, are shown in FIGS. 1-1B. As will be shown, system software can be loaded onto a computerized device 12 which the user uses, or software can be loaded onto at least one computerized device 12, then accessed and used by at least one other computerized device 12a-12b.

Turning to FIG. 1, in one embodiment, the at least one computerized device 12 can be comprised of a server computer, which can both store the software and be accessed and used. The software would be added to this computer and a user would access this computer directly.

Turning to FIG. 1A, the at least one computer can be comprised of a network of computers, represented here as 12, 12a, and 12b. The software can be loaded 16 into some or all of the computers 12, 12a, 12b, and the user may be able to access and use one, some, or all of the computers 12, 12a, 12b.

Turning to FIG. 1B, in another representative embodiment, one computer 12 can be a server and a second computerized device 12a can interact with each other. Data can be entered into the server, or data can be entered into the second computer 12a such as testing data, and the data be transferred from one computerized device to the other. Also, the second computerized device 12a can access and use the software on the server computer 12, or both computers 12, 12a may independently have the pre-programmed software. When the second computerized device 12a finishes a task, it can load the finished work product onto the server 12.

Turning particularly to FIGS. 1 and 2-4, as indicated by the dashed arrows, some or all of the steps of the methods herein can be completed, or completed in a modified order, to represent a number of embodiments of the invention herein.

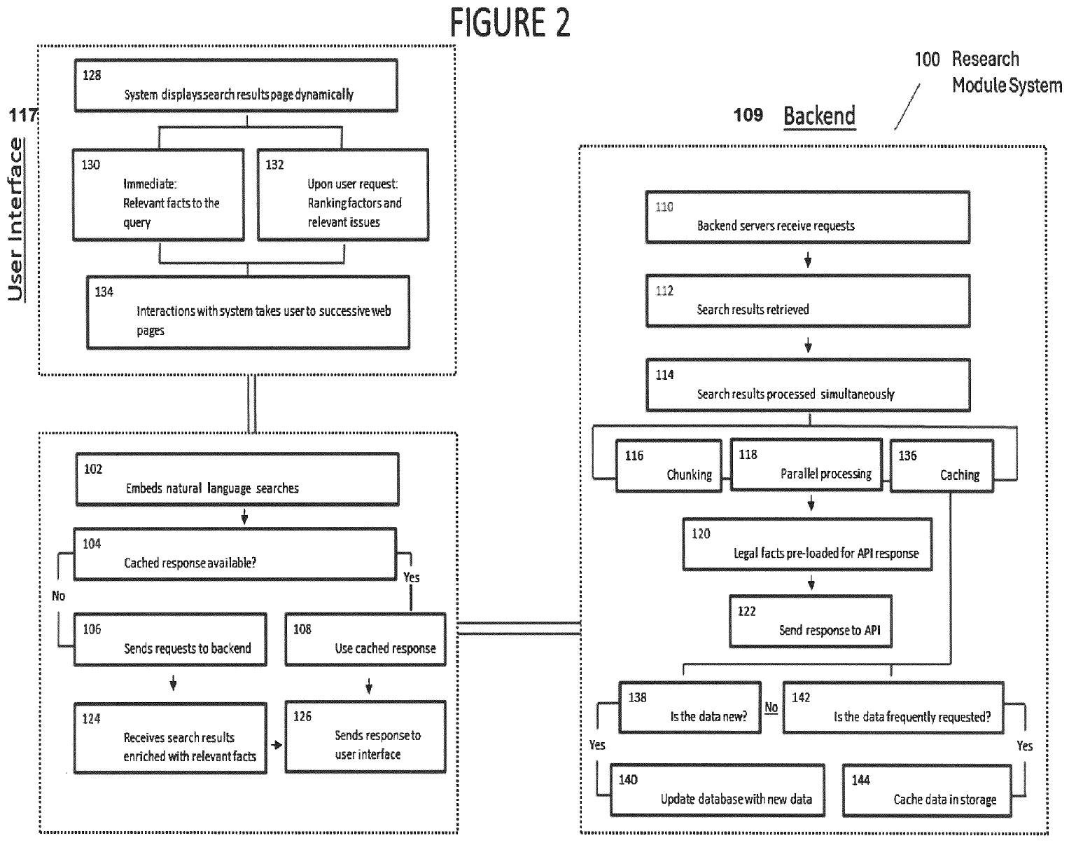

At least one or more user(s) accesses the pre-programmed software of the system 2 at 14. If the user is conducting legal research, a research module 10 can be implemented in accordance with the system's techniques and mechanisms at FIG. 2 in some embodiments. The user typically starts a piece of research by entering a query 16 into the system with the at least one computerized device 12 via a user interface 117. The user can enter the query by asking a legal research or similar question via natural language or other type of query in the art. The at least one computerized device 12 can be accessed via the interface 117 with any known and suitable method in the art, such as, e.g., a keyboard, mouse, audio or visual interaction, or a combination.

The system 2 chooses the references it determines to be most relevant to the query 18. The system 2 can use any pre-programmed methodology known in the art such as semantic search and machine learning to make this selection(s). The system 2 can do this in part by creating an embedding of the query and finding the most similar embeddings in a vector database or databases of court opinions and other legal authorities. A vector database is a collection of data stored as mathematical representations, which makes it easier for machine learning models to perform tasks such as semantic search by enabling efficient comparison and retrieval of data based on their vectorized forms.

The system's 2 semantic search functionality further allows users to write natural language queries and recommends relevant results by analyzing the broader meaning of the query beyond its keywords plus the content of the references in the database. The system 2 can use a custom LLM fine-tuned to generate embeddings that it stores in a vector database. A LLM is a type of AI software trained on large sets of data that can, among other abilities, recognize and generate text.

LLMs use neural networks to process and comprehend vast language data sets. A neural network is a computational framework comprising interconnected nodes arranged in layers. Each node functions as a mathematical operator to transform and capture information in a meaningful way. These operations, analogous to the functioning of neurons in the human brain, process information and discern patterns within the data sets.

LLMs can be fine-tuned to generate embeddings, numerical representations of objects (e.g. words) that capture semantic relationships, by adjusting the model's parameters, such as weights and biases, to optimize its performance. This adjustment process tailors the LLM to generate embeddings that encapsulate the intricacies of targeted language patterns, such as legal text. The system 2 stores embeddings in a vector database where the closer objects are to each other in vector space, the more similar they are in semantic meaning.

When a user enters a search or query 16, the system 2 generates an embedding of their query. Subsequently, an algorithm is employed to create similarity scores between the query embedding and the embeddings stored in the vector database. The most similar references are, in turn, recommended to the user.

Legal domain specific semantic search allows the system to recognize the nuanced meaning of legal terms. The system's 2 approach considers synonyms and variations of legal terms ensuring that relevant documents are retrieved even if they use different phrasing. This serves the critical role of reducing the number of irrelevant search results recommended which saves time because irrelevant results can cause attorneys to spend more time researching an issue than they or their clients expect. Semantic search offers distinct advantages in handling complex queries with multiple dimensions, ensuring users find information even in challenging scenarios.

The method of analyzing the broader meaning of a search query to find references with similar significance differs from the traditional platform approach that matches keywords or Boolean terms and connectors queries largely irrespective of the context, relationships, and import of the words used in a search query. For instance, an attorney researching a breach of contract legal question on a traditional platform with keyword matching is limited to searching, “breach of contract offer revocation voicemail.” In contrast, the system allows the user to search in natural language such as, “Cases where there was not a contract because an offer was revoked by leaving a voicemail.” The system returns relevant results that capture the broader meaning of the natural language query beyond keyword matching for words like “breach” or “offer” and captures the range of meaning communicated by phrases like “not a contract” and “leaving a voicemail” in relation to the other words in the query, references in the databases, and the vast LLM data set.

The system 2 then analyzes and displays ranking factors for each search result 20. The system 2 can provide quantitative indicators such as similarity scores or citation analytics (e.g. the number of times a court found for the same party as the cited reference on an issue compared to the number of times founded for another party). Turning also to FIG. 2, this step, in some embodiments 132 performed upon user request, also allows the user to review qualitative indicators such as, “the result cites . . . ” when that citation is the controlling authority or of strong precedential value. Together, these indicators provide attorneys with a faster and more accurate way to determine whether a reference is good law for the attorney's specific research objectives.

The method of transparently providing quantitative and qualitative indicators stands out relative to opaque methods offered by traditional platforms such as legal citators that indicate whether a reference is good law primarily through citator flags. Current approaches rely on human editors to match emphatically-defined citation treatment categories with ambiguously-worded legal authorities, necessitating a level of subjective interpretation incongruent with objective categorization. In contrast, the system's 2 method offers the user clear insights into the basis for ranking results, which enhances the user's trust in the reliability of search results and saves the user time.

The system 2 can then retrieve relevant legal issues and facts from each search result based on a user's query 22. The system 2 can use suitable methodology, such as LLMs, to title legal issues by synthesizing pertinent sentences from the reference's text into a concise description. Turning additionally and briefly to FIG. 2, this process, performed in some embodiments at 132, automates manual processes seen in current approaches. For both legal issues and facts, the system 2 stores retrieved legal issues and legal facts in flexible databases to model relationships between issues, facts, and other legal data. The system 2 tailors the issues and facts it retrieves to users' specific research objectives based on their queries so each issue or fact displayed is presented for its semantic relevance to the query.

Legal issues tend to be problems or questions subject to dispute that can be brought before a court of law or similar tribunal for resolution. Attorneys may identify legal issues by asking “was the/there [legal issue]” (e.g. offer revocation; causation, etc.). Legal facts are pertinent information that an adjudicator (e.g. judges, arbitrators, etc.) would probably consider when reaching a decision. For example, “the supplier left the buyer a voicemail saying the parts were no longer available” or “the expert witness testified that exposure to the chemicals increased risk of disease.”

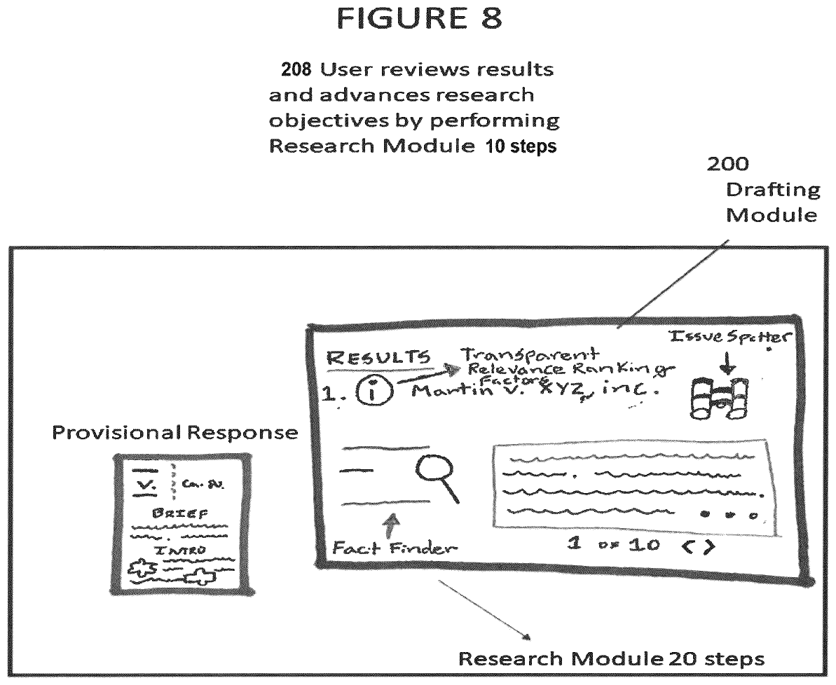

Users can access the search result's legal issues and facts by interacting with the user interface 134 and by, in some embodiments, clicking on icons as shown, for example, in FIG. 8. In some embodiments, when a user clicks these icons, lists of legal issues or facts appear. They are hyperlinked so when clicked, they take the user to the precise location where the issue or fact appears in highlighted text on the reference's web page. This provides attorneys with a more reliable and robust way to initially assess whether a search result is on point.

The user can then click on any legal issue(s) or fact(s) to go directly to its location in the reference 24. By displaying relevant legal issues and facts on the search results page 22, and the user then clicking on any legal issue(s) or fact(s) 24, the system 2 overcomes limitations found in extracts and legal taxonomies to save attorneys time.

This portion of the system 2 method offers a comprehensive and precise display of legal issues and facts because they are some of the main attributes an attorney considers when making an initial assessment on whether a search result is on point. The method aligns well with how users evaluate search results, sparing attorneys from the frustration of wasting time by reading once-promising references that upon further review are no more than false positives.

Take as illustrative the following example. A user sees a highly ranked court opinion search result with matching keywords for a query about whether leaving a voicemail saying product parts are no longer available can constitute revocation of an offer. The traditional platform renders an extract of sentence fragments where “revoked,” “voicemail,” and “offered” are bolded which leads the user to click on it. Frustratingly, the user finds that instead of a reference discussing offer revocation under contract law, the traditional platform recommended an irrelevant case about a defendant who acknowledged in a voicemail that her real estate license was revoked, but still offered to represent the seller for a reduced commission. False positives waste time and cause even more inefficiency when users constantly revise search terms to try to get results that yield better extracts. Too often on traditional platforms, not only does keyword-based search fail to capture user intent, but the extracts in the search results also struggle to reliably convey the references' relevance.

Regarding legal classification, by relying on human editors to manually categorize the issues, current legal taxonomies are vulnerable to instances where complex issues do not fit neatly into rigid categories. Under such circumstances, subjective human editors can inadequately categorize an issue by grouping it with a broader category that does not provide the nuance that an attorney needs to make an initial assessment of the reference's relevance.

The user can click on an issue or fact on the reference page to retrieve and display related legal issues to each previously identified issue and analogous legal facts to each previously identified fact 26. The user can then see any legal issue or fact of interest.

The user accesses these upon request, in some embodiments via ranking factors and relevant issues as in 132, by clicking on icon(s) representing the legal issue or fact 28. The system 2 retrieves related legal issues that were not discussed in the reference and are relevant to the user's query.

For both related legal issues and analogous legal facts, when a user clicks the icon(s) 28, the user interface 30 can take a user to a new automated search results page featuring relevance based on the original query and the related issue or analogous fact 30. The system presents to the user a new search results page with relevant references based on semantic understanding of the initial query and updated legal fact retrievals with legal issues and ranking factors available upon request. The user can repeat the process to efficiently conduct thorough and exhaustive legal research.

Related legal issues are legal issues that tend to “hang together” in that the presence of one correlates with the presence of another. Attorneys typically find that a reference is on point for a certain legal issue, but another related issue may fall outside the reference's scope. For example, an attorney representing a client in a breach of contract dispute is researching court opinions that discuss a legal issue such as “offer revocation.” The attorney finds an on point court opinion for that issue, but the facts of the matter also involve related legal issues. For the attorney's case, a judge must resolve an additional question, “was there an option contract?” (i.e., an enforceable agreement that restricts the ability to revoke an offer within a specified time frame). From there, the attorney can pursue additional related issues relevant to the matter such as validity or lapsing of an option contract.

Analogous facts share underlying attributes with other facts to such an extent that attorneys consider them useful to evaluate. When attorneys can successfully argue that references with analogous facts have precedential value, they increase the likelihood of success for their clients. Analogous facts, although significantly different in context or circumstances, are especially useful when clients' unique set of facts do not afford more routine comparisons to precedents. For example, “the employer sent an email to the candidate to withdraw the job offer due to unforeseen budget constraints” is analogous to “the seller left the buyer a voicemail saying the product parts were no longer available” for an offer revocation legal issue. The communication method (email) and the reason for revocation (unforeseen budget constraints) are underlying attributes that share similarities with the original fact about the seller revoking an offer through a voicemail because the parts are no longer available. While the specific legal rules and doctrines may differ between contract law (offer revocation) and employment law (job offer withdrawal), the underlying concept of revoking an offer before acceptance is analogous. Attorneys typically evaluate and rely on multiple references with analogous facts to strengthen their arguments.

Turning to FIG. 2, a more detailed Research Module System 100 for carrying out the steps of the research module 10 featured in FIG. 1, is shown and described. The Research module system 100 is comprised generally of a user interface portion 117, a Backend portion 109, and an API portion 101.

The user interface 117 portion provides a link between the user, and the software operating system and at least one computerized device 12. The interface 117 provides a way for the user to implement commands to the at least one computerized device 12 that the software can implement. Through the interface portion 117, the user can see the results, and add, alter, or end commands. The backend portion 109 is the portion of the software application or code that allows the system 2 to implement the user's inputs via the interface 117. The backend 109 generally conducts operations, stores most data and syntax (command rules), and cannot be accessed by a user.

The API portion 101 (Application Programming Interface) is a software intermediary that allows two applications to talk to each other. It is essentially a contact of service between two software applications. Herein, the API 101 provides contact and coordination between the user interface 117 and backend portion 109 that allows the backend 109 to execute instructions from the user interface 117, the backend 109 to communicate the results of execution back to the user interface 117, the user interface 117 to transmit any updated instructions back to the backend 109, and so forth.

An overview of the research module 100 will be featured, discussing the user interface 117, API 101, and backend 109 in further detail. The API 101 embeds natural language queries 102 and determines whether cached responses are available 104. If the response (i.e. search results) is cached, the API uses the cached response 108 and sends it to the user interface 117 to display the search results at 128. If the response is not cached, the API sends requests to the back end 106 for further action.

Backend 109 servers receive requests from the API 101 at 110. The backend 109 analyzes at least one vector database to identify embeddings with the highest similarity level to the embedded query and retrieves search results 112 by pointing the API 101 to the databases where the references are stored. From here, each search result is typically processed simultaneously 114.

After processing 114, depending upon a determination of the system 2 on the best way to proceed, the processing may involve splitting the retrieved search results into chunks 116, parallel processing the search results 118, incorporating frequently used search results in a cache 136, or a combination of these. Extracted legal facts are pre-loaded for API response at 120. The backend 109 sends a response 122 to the API 101.

The API 101 receives the search results enriched with any relevant facts response 124 from the backend 109 and sends the response to the user interface 117 at 126. The user interface 117 displays the search results page dynamically 128 with relevant facts displayed immediately 130 in some embodiments, and, in some embodiments, ranking factors and relevant issues displayed upon user request 132. From here, a user interacts with the system to navigate seamlessly to successive web pages 134.

Meanwhile, on the backend with cached data 136, the system 2 analyzes the search results to determine whether any such data is new data 138 and if so, to update the database with new data 140, or if the data is frequently requested 142, to cache the data in storage 144. In some embodiments, the backend uses algorithms to analyze whether a search result has surpassed a threshold to be cached. The purpose of caching in various embodiments is to be able retrieve data faster and deliver an overall higher performance system.

With the research module 100, a user can intuitively retrieve search results, including related legal issues not discussed in a reference 112 because the backend 109 leverages a flexible database that stores relationships between legal issues, court opinions, and other legal data. The system 2 uses algorithms to take the legal issues retrieved and upon request, identifies other legal issues that coincide with the retrieved issue in other references, but do not appear in the selected reference. The legal issues that are updated in the database or cached in storage through the process of 138-144 accumulate over time partly through user engagement of the automated titling mechanism at 132. The titling mechanism works by first prompting a fine-tuned LLM to identify sentences that point to legal issues and then synthesizing those sentences into a concise statement that serves as the title of the issue. Users run searches and legal issues the system 2 retrieves are incorporated into the flexible database of the system 2.

Like the flexible database for legal issues, the system stores legal facts and other legal data for the purpose of analyzing analogous legal facts. Moreover, the system's machine learning model predicts whether two facts are analogous. Facts with the highest score are recommended to the user when they click on a fact 26 to access the results. The system 2 uses algorithms to recommend results to the user and data from past user engagement (e.g. clicks) informs what the algorithm recommends.

The method of actively anticipating future directions for an attorney's research by suggesting legal issues and facts from other references and automatically providing relevant search results differs from the cumbersome legal taxonomies and passive search features offered by traditional platforms. The system 2 method offers an intuitive way for an attorney to find relevant references with related legal issues and analogous facts because they are some of the main bases for raising work product quality. Clients are often in “messy” legal situations and the endeavor for every attorney is to employ precision, persistence, and perspicacity to make a “clean sweep.” However, finding related but undiscussed legal issues and analogous facts can prove as elusive as sweeping the final thin line of debris into the dustpan.

By taking a malleable and responsive form to encompass the deep and wide ways users approach research, among other advantages, the system 2 method eliminates the need to scour taxonomies and constantly revise keywords which saves time and elevates the legal research user experience.

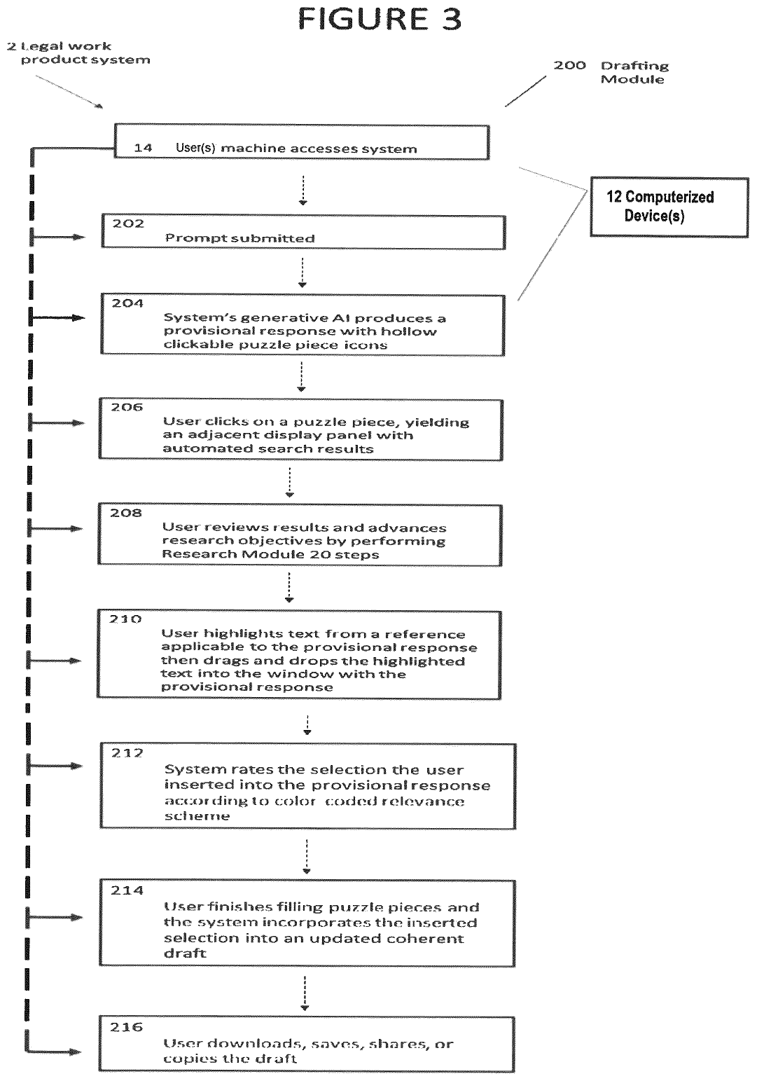

Turning to FIG. 3, an overview of the drafting module 200 is shown. As with the research module, at least one user accesses the pre-programmed software of the system 2 at 14.

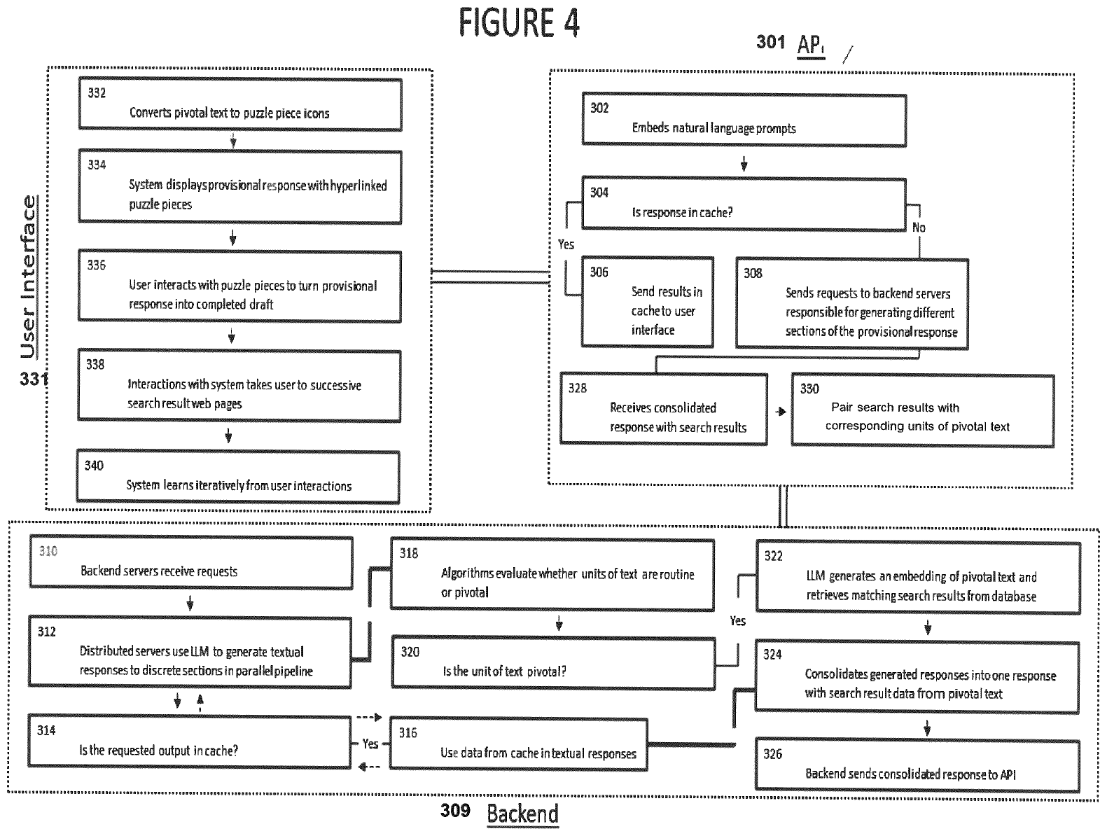

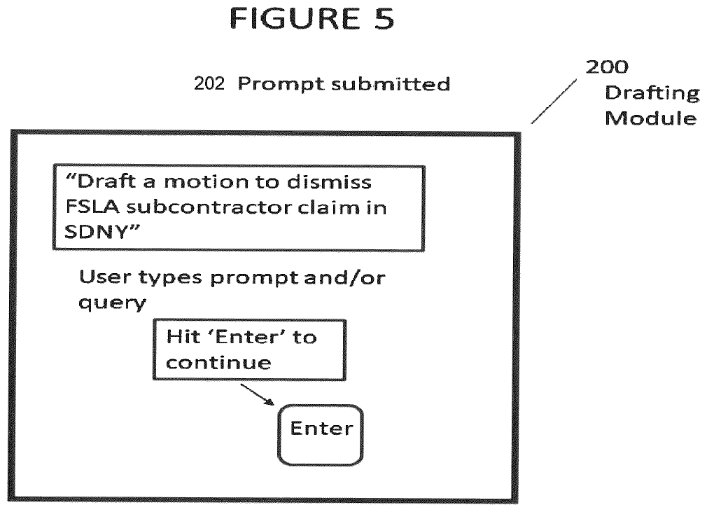

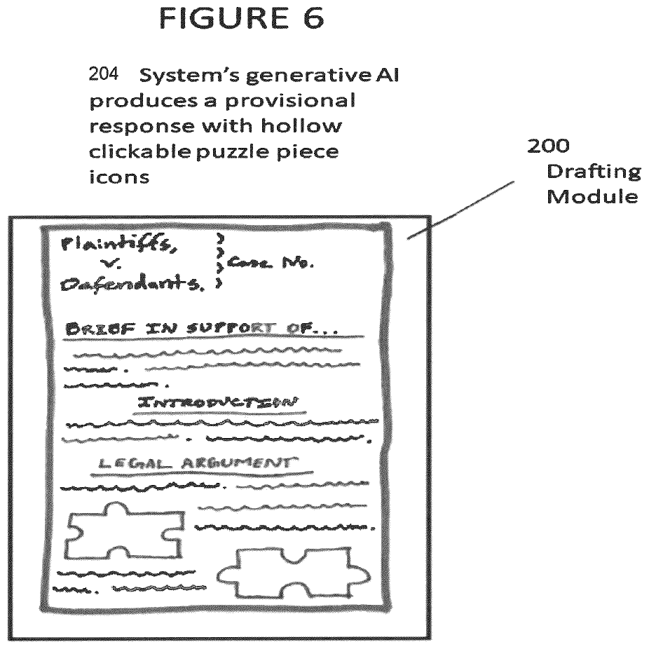

A prompt is submitted by a user 202, typically to begin a document which may be for litigation or transactional practice (e.g. contracts). As an example, a user may need to draft a brief in support of a motion to dismiss. The user can submit a prompt 202 regarding a brief. FIG. 5 provides an illustration of the prompt being entered 202. The system 2 uses generative AI, as shown in the drafting module system 300 featured in FIG. 4, to produce a provisional response to the user's prompt 204. FIG. 6 provides an illustration of an example provisional response to a user's request 204, showing a provisional response to a request to draft a motion to dismiss.

The produced provisional response 204 is modulated by the system's 2 conversion of pivotal text to puzzle piece icons 332 and the system's 2 display of a provisional response with inclusion of hollow puzzle piece icons within the textual response 334 that can be hyperlinked. The hollow appearance is meant to suggest that the puzzle piece is “missing” and the user needs to find it to complete the draft (re: puzzle). The response is provisional because the hollow puzzle pieces are presented in lieu of text for pivotal parts of the written response that would benefit from the review and expertise of an attorney. Turning briefly to FIG. 4, the system 2 can do this in some embodiments by evaluating text to distinguish between routine parts of a response and pivotal parts of generated text 318.

Generative AI leverages LLMs that can be used herein to produce human-like conversational text through a process called natural language generation. These LLMs, such as GPT-4, are trained on vast amounts of textual data to understand patterns, context, and syntax within language. When generating text, as herein, the model utilizes techniques like auto regression, where it predicts the next word or sequence of words based on the preceding context. Additionally, fine-tuning can be applied to tailor the model's output for specific tasks or manners of speech. By continuously refining its understanding through training and exposure to diverse texts, the LLM becomes adept at mimicking human language, producing responses that are contextually relevant, coherent, and indistinguishable from those of a human interlocutor.

Routine text comprises the most straightforward aspects of a legal draft. Such text is standard and definitive, necessary but not sufficient for advancing a client's objectives. Routine text tends not to vary across different legal drafts. Its scope extends from formatting (e.g. headings, topic sentences, transition sentences, etc.) to well-settled law or principles (e.g. legal standard for motions, black letter law, etc.). For example, “In general, an offer can be revoked at any time before acceptance takes place” states black letter law about the legal standard for an offer to form a contract. This example is most likely routine and, in some embodiments, the system generates text that includes citations to legal authorities in relevant jurisdictions.

Pivotal text represents the most complex parts of a legal draft. Pivotal text is necessary and sufficient for advancing a client's objectives. Pivotal text tends to vary across different legal drafts and is contingent on the matter's unique factual circumstances and legal precedent in the relevant jurisdiction(s). Its scope centers on legal issue analysis where there are or could be “arguments on both sides” (i.e. resolution requires interpretation). For example, text that would analyze whether leaving a voicemail constitutes revocation of an offer is most likely pivotal and the system would display a hollow puzzle piece preceded by routine text like a topic sentence 334. The system creates a provisional response modulated with clickable puzzle pieces that allow attorneys to benefit from generative AI's ability to rapidly produce text while mitigating the risk of inaccuracies by only generating text for routine parts of the draft, leaving pivotal parts as the missing puzzle pieces for attorneys to fill.

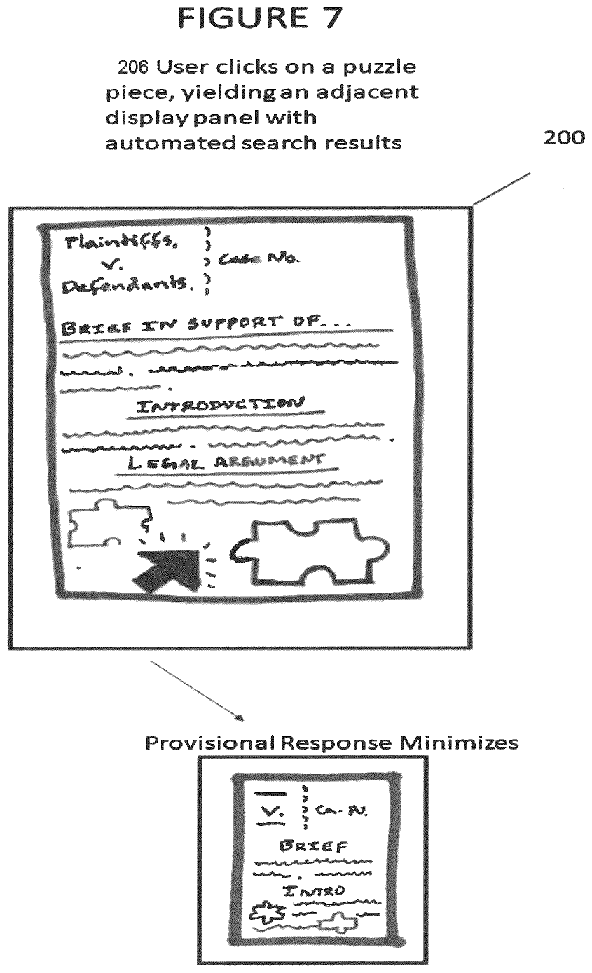

In some embodiments, the provisional response to the user's prompt contains hyperlinked puzzle piece(s), and when a user clicks on a puzzle piece, the system 2 takes the user to a separate or adjacent display panel or window displaying search results 206. FIG. 7 provides an illustration of an example of a display panel with search results being shown.

In some embodiments, clicking on the puzzle piece 206 leads to the adjustment of the layout within the same web browser tab. Turning also to FIG. 4, the search results are semantically relevant to the pivotal text replaced by the puzzle piece in the system at 332.

Hyperlinks facilitate integration of the system's 2 drafting and research modules. The clickable puzzle pieces serve as interactive shortcuts which can also allow users to easily navigate between the provisional response in the drafting module 200 to automated search results from the research module 10. Other uses of hyperlinks in the system 2 include, but are not limited to, clickable citation text that takes a user to a specific reference which is an example known in the art.

Instead of directing a user to a new webpage or launching a new tab, when a user clicks on a puzzle piece, the system rearranges the existing content. The system shrinks or minimizes into a corner the window displaying the provisional response, while the new content expands to occupy most of the screen space. This approach enables users to view both the original and new content simultaneously within the space of the same browser tab, providing a seamless browsing experience without the need for additional tabs or windows.

Automated search results relevant to a puzzle piece are displayed in the adjacent panel. When users click a puzzle piece, an adjacent display panel opens, showcasing search results retrieved 322 from the backend 309 directly related to the puzzle piece and its surrounding context. Users benefit from this automation as they instantly obtain resources to “fill” a missing puzzle piece by reviewing relevant search results without the need for manual searches.

In some embodiments, explanatory text (e.g. a search query) accompanies the search results to provide insight into what the system “asked” to get the automated search results 206. The automated search results allow attorneys to immediately access semantically relevant references for the pivotal parts of the provisional response. This balanced approach accelerates drafting of the routine parts of their work product and virtually eliminates manual searching for relevant references for the pivotal parts. The system 2 minimizes the provisional response on the same browser tab to make it easier for users to navigate between the two displays. In some embodiments, users can toggle between the search results display and the provisional response display such that one minimizes as the system 2 expands the other. Furthermore, in some embodiments, the user can click a button to add more puzzle pieces to the provisional response to go beyond the original pieces generated by the system. These additional puzzle pieces also yield relevant automated search results in an adjacent panel, allowing users to further refine their drafts, still without the need for manual searches.

In contrast, current approaches often require users to make follow-up prompts in order to elicit intended responses, shifting the burden for generating coherent and relevant responses from AI chatbots to users. Follow up prompts are a core feature of AI chatbots that users can experience as a limitation when they make nuanced or complex requests. Users often must redirect chatbots in attempts to elicit accurate and relevant responses. The main causes are rooted in AI chatbots' architectures. AI chatbots operate by tokenizing the prompt and generating new tokens (i.e. text). They have fixed context windows which set an upper limit on the number of previous tokens it can analyze when generating each new token. Practically speaking, this can lead AI chatbots to “forget” important context previously communicated in the conversation. Moreover, transformer-based AI chatbots struggle to handle long-term dependencies such that they have difficulty connecting relevant information separated by a large number of tokens. This issue is addressed in embodiments herein. These foundational limitations decrease the efficiency and utility of AI chatbots in serving their intended purposes.

The disruption caused by the need for frequent follow-up prompts in conversations with AI chatbots can create a disjointed user experience far removed from natural conversational styles. Instead of smoothly progressing through a dialogue, users are forced to repeatedly intervene to clarify or correct the AI's responses, which wastes time and frustrates users. The inability to deliver natural conversations due to the constant need for follow-up prompts can erode user confidence in AI chatbots' competence and reliability under current approaches. This lack of confidence can diminish users' willingness to rely on AI chatbots for critical tasks such as legal drafting, ultimately undermining the utility and adoption of AI chatbots.

After the user clicks on a puzzle piece, the system 2 presents automated semantic search results relevant to the puzzle pieces from the provisional response, typically with search result displayed at a panel or window 206. Furthermore, for each search result, the system 2 can provide a user with ranking factors and showcase relevant legal issues and legal facts.

The user can then review the results 208 and can, if the user chooses, advance research objectives by performing research module 10 steps. FIG. 8 provides an illustrative embodiment of this step 208. A user can easily review and navigate through relevant search results to find text from references that the user deems suitable for the pivotal parts of the provisional response 208, and interact with the system to be taken to successive search result pages, such as at step 338.

The system 2 can use pivotal embeddings from the provisional response, such as at step 322, to recommend semantically relevant search results for each puzzle piece. The system 2 measures the similarity between embeddings from the pivotal parts of the provisional response and embeddings from legal references in its database. From there, the system can integrate its research methods 100.

The system integrates legal drafting and research, disparate and tedious tasks under current approaches, into a single streamlined process augmented by automation. Its modular approach to legal drafting is elevated by its seamless legal research functionality. Modularity benefits users by forthrightly showing the discrete areas that call for professional judgment since they would likely cause the most follow up prompts if they were rendered as text instead of clickable puzzle pieces. Seamlessness benefits users by allowing users to quickly access relevant references without having to engage in incessant follow up prompts or constantly revise keywords for search queries. In some embodiments, attorneys can start with legal research and generate a provisional response based on search results, a reference, or sections of a reference.

The user can then, in some embodiments, highlight any text from any reference applicable to the provisional response, and drag and drop the highlighted text into the window with the provisional response 210. The user can further capture and move text by any other suitable means in the art.

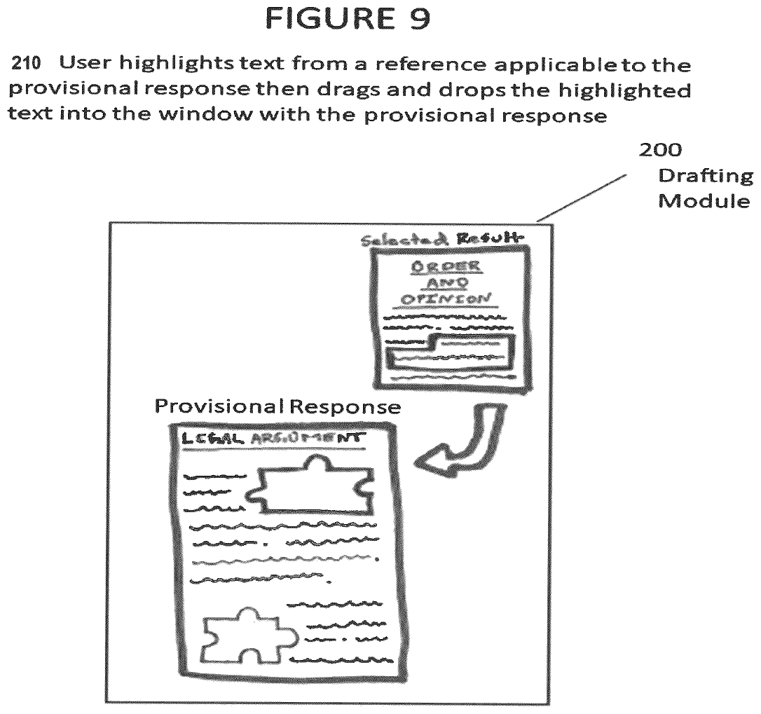

Herein, the puzzle solving functionality allows a user to review references from automated search results, highlight text relevant to the pivotal parts of provisional responses, drag and drop highlighted text with their mouse into a minimized windows containing the provisional responses 210, and in some embodiments, experience a color-coded relevance scheme that rates the text and places it into the applicable puzzle piece 212. Turning to FIG. 9, an embodiment of step 210 is shown.

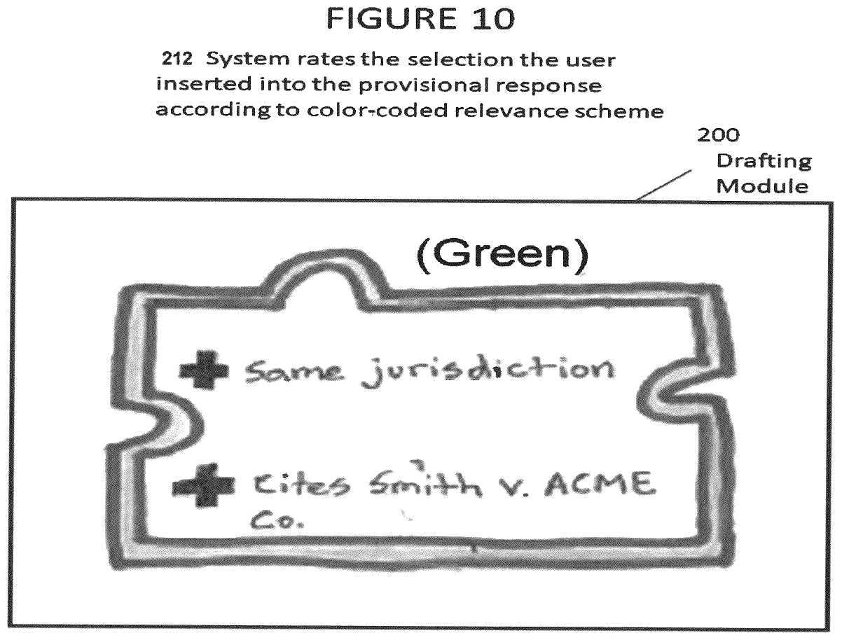

In some embodiments, the system 2 can rate the selection that the user inserted into the provisional response 212. The rating can be conducted according to any suitable method in the art, and in some embodiments, conducted according to a color-coded relevance scheme. Turning to FIG. 10, an embodiment wherein color coding relevance is used is shown.

The system 2 can employ ranking factors that include, but are not limited to relevance, jurisdiction, and currency. These ranking factors amount to scores and after the user drops the highlighted text into the provisional response's window 210, the score ranges can be represented as colors. Specifically, green (good fit), yellow (caution), and red (poor fit). Green indicates the material is most likely acceptable but should have a quick review. Yellow indicates caution and careful checking should be used. Finally, red indicates material that is likely not relevant, or is technically relevant, but may move in a direction opposite to that of the general text of the document.

If a puzzle piece outlines in green, it will also typically state reasons why it is a good fit for the user's draft such as it being cited in other cases where motions to dismiss were granted.

A yellow piece may state the reasons why the user should proceed with caution such as it being an unreported court opinion that hasn't been cited in other cases. Furthermore, red in this scheme tends to mean that the system analyzes a good technical match for what the researcher is looking for, but there is a fundamental flaw that limits its usefulness. For example, it could be a false positive or misleading reference. Whatever the case, it is to be treated with extra caution.

Moreover, for green and yellow puzzle pieces, the puzzle piece tends to fit into the missing piece. If the system 2 predicts that the puzzle piece fits, it will explain the criteria, outline in green and place it into the vacant spot. If the system recommends proceeding with caution, it outlines in yellow and places the puzzle piece in, but states why the user should proceed with caution. If a puzzle piece is not the same shape and does not fit, this is a more serious warning indicator. It can outline or color in red and state the reason why the system thinks the user should not include it, such as if the court opinion was superseded by statute. The user can review and if the user believes the text of the red puzzle piece does fit, the user can click on a prompt to overrule the system to place the piece. In some embodiments, the red puzzle piece will not quite fit until the user completes their draft.

In some embodiments, this is the system's “gamification” aspect. When a user ultimately chooses to drag and drop selections from the search results, there is a game-like quality where the user sees how their selection is rated by the system. If it is “good,” the user is “rewarded” with the green outline and if it is “bad” they “lose” with the red outline. The gamification aspect taps into the user's competitiveness to want to get green puzzle pieces. It also builds trust with the user if they come to recognize the system's evaluations of green/yellow/red as likely to be valid, or at least worth considering. This typically improves as the user gains experience with the system, and the system learns iteratively over time 340. The ability to add copied text from references into a provisional response and receive an immediate evaluation of the text's “fit” with the response, turns the daunting and time-consuming tasks of legal research and drafting into an engaging workflow with game-like appeal.

The shortcomings of current approaches are most evident when matters are complex. First, traditional research platforms often lack interactivity, forcing users to manually copy and paste information into their documents without immediate feedback on its relevance or suitability. Second, traditional platforms and AI chatbots rely greatly on manual input and analysis from users. This makes implicit demands on users' time that make them less productive and clients less satisfied. Third, AI chatbots' architectures can lead to all-or-nothing propositions where if the chatbot doesn't accurately interpret or comprehensively source a reference, it can undermine the entire response as the chatbots' mistaken premise compounds through auto-regression to an inaccurate response.

By enabling users to quickly assess the fit of copied text with AI-generated responses, this capability streamlines the research process and provides users with valuable guidance on incorporating relevant legal authorities into their drafts.

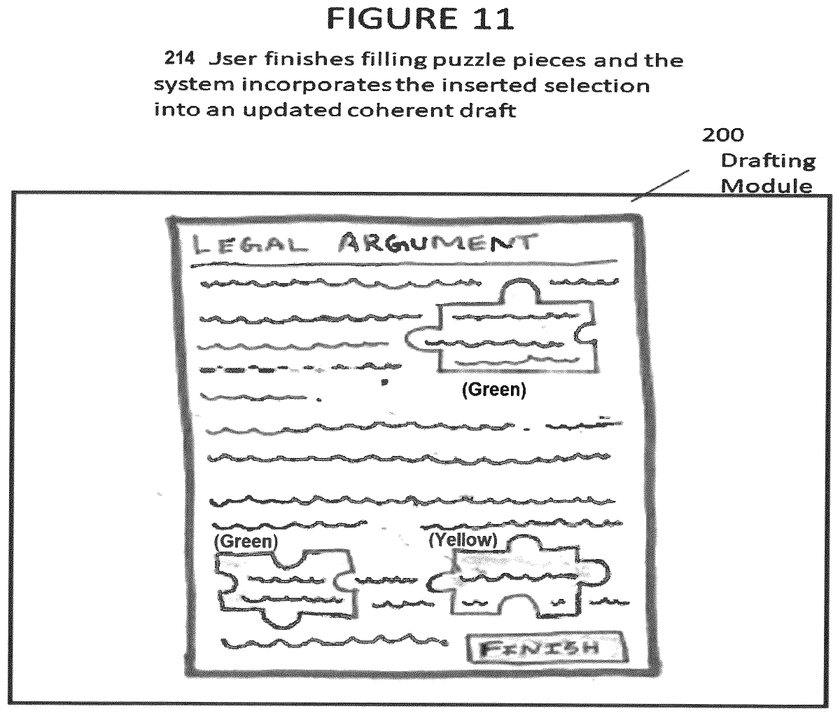

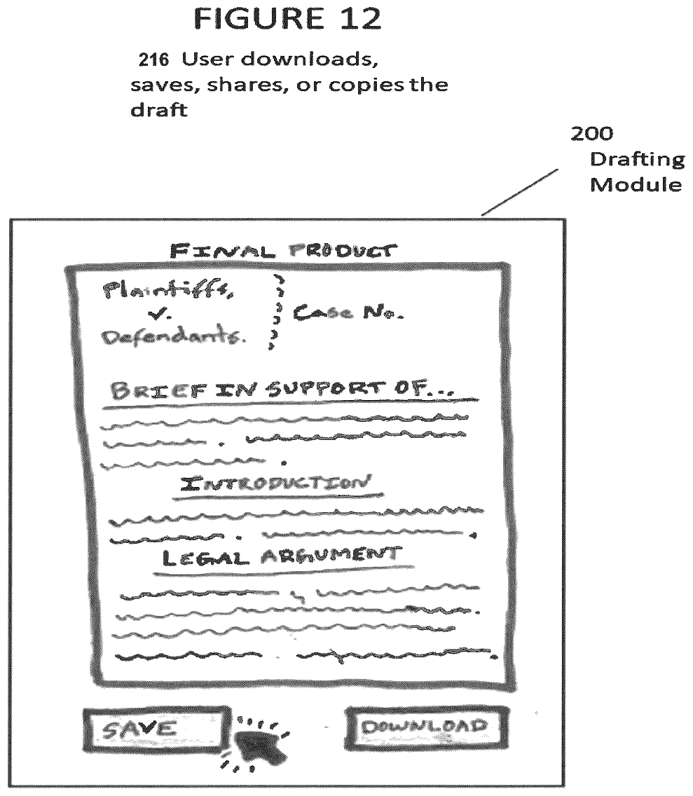

In some embodiments, the user can then finish filling any remaining puzzle pieces and the system 2 incorporates the inserted selection into an updated coherent draft 214. The system 2, in some embodiments, does this by utilizing LLMs and NLP techniques to refine a user's puzzle insertions into a coherent draft 214. An example of this kind of embodiment can be seen at FIG. 11. The user, if they choose, can download, save, share, or copy the draft 216 or take any other appropriate action with it. An embodiment showing a user saving a draft is shown in FIG. 12.

By leveraging the vast amounts of text data from its training models, the system analyzes the structure, context, and semantic meaning of the provisional response. This allows it to add routine text around the pivotal text inserted by the user into the various puzzle pieces. Through iterative learning and refinement 340, the system continually improves its ability to understand and generate text, ensuring high-quality results that meet the user's needs. Users can download, save, copy, or share their completed drafts.

Iterative learning involves updating the system's models based on data sets augmented by user interactions and feedback. As the model processes this feedback, it adjusts its parameters and refines its internal representations, gradually improving its ability to organize and structure information in a coherent manner.

Cohering pivotal text into the provisional response allows attorneys to quickly incorporate research findings without the need for extensive manual editing to “make the pieces fit together,” as can be seen in FIG. 11. The system 2 maintains logical flow throughout the draft and effectively “completes the puzzle.” This obviates the need seen in AI chatbots for users to submit additional prompts to move drafts closer to fulfilling attorneys' objectives. Furthermore, the iterative nature of the learning process ensures that the system's 2 coherence mechanisms evolve over time, adapting to changing linguistic patterns and user preferences. As the model continues to learn from user interactions and feedback, it becomes increasingly adept at meeting the diverse needs and expectations of attorneys, further enhancing their experience and productivity.

Turning to FIG. 4, a more detailed drafting module system 300 for carrying out the steps of the drafting module 200 featured in FIG. 3, is shown and described. The drafting module system 300 is comprised generally of a user interface portion 331, a Backend portion 309, and an API portion 301.

The API 301 embeds natural language prompts 302 and determines whether cached responses are available 304. If the response (i.e. AI-generated provisional response) is cached, the API 301 sends the cached response to the user interface at 306. If the response is not cached, the API sends requests to the backend servers 308, and typically to backend servers responsible for generating different sections of the provisional response. The servers of the backend 309 receive requests 310 from the API 301. The backend 309 servers are programmed to generate textual responses to discrete sections 312. In some embodiments, the system can use LLM or similar technology, to generate in parallel, discrete sections, such as, for examples, introduction, procedural history, discussion, or conclusion 312, and in some embodiments, specific sentences, phrases, or keywords.

The backend 309 determines whether output requested from the API 301 is in cache 314 and if it is available, the backend 309 uses cached data to generate a part of the textual response 316. As text generates, algorithms can evaluate whether units of text are routine or pivotal 318. If a unit of text is determined by the system 2 to be pivotal 320, the system 2, in some embodiments using an LLM, can generate an embedding of the pivotal text, and in some embodiments the surrounding routine text and user prompt, and retrieves semantic search results from databases 322.

The backend 309 consolidates the generated responses into one response with search result data with pivotal text 324. The API 301 can point the user interface 331 to the search result data with pivotal text. The backend 309 consolidates the generated responses into one response with search result data with pivotal text 324. Then the backend 309 can send the consolidated response 326 to the API 301.

In some embodiments, after the requests are sent to the backend servers responsible for generating different sections of the provisional response 308, and after the appropriate steps are performed by the backend 309 as described herein, the API 301 receives the consolidated response with search results 328 and pairs the search results with corresponding units of pivotal text 330.

Moving onto describing more specifically the activity of the user interface 331, the user interface converts any suitable pivotal text to puzzle piece icons 332. The system 2 can display a provisional response with hyperlinked puzzle pieces 334 that, when clicked, automatically take the user to relevant search results. A user can interact with puzzle pieces until the provisional response is turned into a completed draft 338 by seamlessly navigating through successive search results web pages 338, thereby executing oversight over the intuitive and explainable generative AI application. The system continues to learn and refine iteratively from interactions with the user 340.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A method of providing and using an AI-based legal research system, comprising the steps of:
providing system software,
providing at least one computerized device for running the system software, accessing the software,
entering a query via a user interface into the at least one computerized device,
selecting a list of one or more references determined to be the most relevant to the query,
displaying at least one search result and displaying at least one ranking factor for each search result,
retrieving and displaying at least one relevant issue, fact, or both for at least one search result,
selecting at least one issue or fact among the at least one search result and transferring to its location,
and retrieving and displaying at least one related issue related to the at least selected issue or fact.

2. A method of providing and using an AI-based legal research system according to claim 1, comprising the further step of:
transferring to a new automated search results page with relevance based on the original query and the first at least one issue or fact.

3. A method of providing and using an AI-based legal research system according to claim 1, comprising the further steps of:
selecting the one or more references by creating an embedding of the query and finding the most similar embeddings in either;
a vector database,
at least one database of court opinions,
at least one database of other legal authorities,
or a combination of these,
wherein the one or more references are selected using;
at least one algorithm,
semantic search functionality,
LLM AI software,
or a combination of these.

4. A method of providing and using an AI-based legal research system, according to claim 1, comprising the further comprising the steps of:
providing a research module system configured to carry out the steps of the research system, comprising the steps of:
providing a user interface portion,
a backend portion,
and an API portion,
wherein the user interface portion is configured to provide a link between a user and the system software via the at least one computerized device,
and wherein the API portion is configured to provide contact and coordination between the user interface portion and backend portion,
and wherein the backend portion is configured to execute instructions from the user interface portion.

5. A method of providing and using an AI-based legal research system, according to claim 4, wherein the API portion provides the further steps of:
embedding and transmitting at least one query,
determining whether at least one cached responses is available,
either:
transmitting the at least one cached response to the user interface portion,
transmitting at least one request to the back end portion for further action,
or a combination of these,
analyzing at least one vector database to identify at least one embedding with the highest similarity level to the query,
retrieving at least one search results, and processing the at least one search result, and
transmitting data from the backend portion to the API portion and on to the user interface.

6. A method of providing and using an AI-based legal research system, according to claim 5,
Comprising the further steps of:
analyzing the at least one search result,
and either;
updating a database with any new data,
caching any new data in storage,
or both.

7. A method of providing and using an AI-based legal work product drafting system system, comprising the steps of:
providing system software,
providing at least one computerized device for running the system software,
accessing the software, submitting a prompt to draft a document,
using generative AI to produce a provisional response document to the prompt,
evaluating the text of the provisional response document and identifying both routine portions of text and any pivotal portions of text,
converting each piece of any pivotal text in the provisional response document to an icon, wherein each icon is displayed within the provisional response document,
activating at least one icon to access at least one piece of pivotal text,
transferring a user via the icon to either a display panel or window displaying at least one search result,
wherein the at least one search result is an automated semantic search result relevant to the at least one icon from the provisional response document,
providing at least one ranking factor within each search result,
providing at least one relevant issue or fact for at least one search result,
reviewing at least one reference from the at least one search result,
capturing and moving any selected text applicable to the provisional response into a specified area of the provisional response document,
rating each piece of selected text inserted into the provisional response document according to a rating scheme, and
filling any remaining icons and incorporating these into an updated coherent draft.

8. A method of providing and using an AI-based legal work product drafting system according to claim 7, wherein the at least one icon is in the configuration of a puzzle piece.

9. A method of providing and using an AI-based legal work product drafting system according to claim 7, further comprising the step of:
sending a user to at least one successive search result page.

10. A method of providing and using an AI-based legal work product drafting system according to claim 7, wherein the selected text is captured and moved by highlighting the selected text, and dropping the highlighted text into a window.

11. A method of providing and using an AI-based legal work product drafting system according to claim 7, wherein each icon is in the form of a puzzle piece.

12. A method of providing and using an AI-based legal work product drafting system according to claim 7, wherein the rating scheme is a color-coded scheme,
and wherein the color-coded rating scheme is comprised of green signaling a good fit of the text within the document, yellow signaling a state of caution regarding the fit, and red signaling a poor fit.

13. A method of providing and using an AI-based legal work product drafting system according to claim 7, wherein each icon is activated by utilizing at least one LLM, at least one NLP technique, or both.

14. A method of providing and using an AI-based legal work product drafting system according to claim 7, comprising the step of:
conducting iterative learning and refinement to continually improve the system's ability to understand and generate improved text.

15. A method of providing and using an AI-based legal work product drafting system according to claim 7, comprising the further steps of:
completing a draft,
and either:
downloading, saving, copying, or sharing the completed draft,
or any combination of these.

16. A method of providing and using an AI-based legal work product drafting system, comprising the steps of:
providing system software,
providing at least one computerized device for running the system software,
providing a user interface portion,
providing a backend portion,
and providing an API portion,
embedding natural language prompts,
determining whether any cached responses are available,
either:
transmitting at least one cached responses from the API to the user interface,
transmitting at least one request from the API to the backend portion,
or a combination of these,
using any available cached data to generate at least one unit of a response text,
determining whether each at least one unit of response text is routine or pivotal, and if it is determined to be pivotal, either;
generating an embedding of the pivotal text,
generating an embedding of the surrounding routine text, and retrieving semantic search results from at least one database,
or a combination of these,
consolidating any generated responses into a response with search result data,
and transmitting any consolidated response to the API portion.

17. A method of providing and using an AI-based legal work product drafting system system according to claim 16, comprising the step of:
converting any suitable pivotal text to puzzle piece icons via the user interface portion.

18. A method of providing and using an AI-based legal work product drafting system according to claim 16, comprising the step of:
displaying a provisional response with at least one hyperlinked puzzle piece configured to take a user to any relevant search results when activated.

19. A method of providing and using an AI-based legal work product drafting system system according to claim 18, comprising the step of:
Interacting with each hyperlinked puzzle piece until the provisional response is turned into a completed draft.

20. A method of providing and using an AI-based legal work product drafting system according to claim 16, comprising the further step of:
providing LLM technology, and using the LLM technology to generate at least one discrete document section of text.
